(19) United States
(12) Patent Application Publication
(10) Pub. No.: US 2024/0308361 A1
(43) Pub. Date: Sep. 19, 2024

(54) Electric vehicle for heavy duty applications

(71) Applicant: BluVein Innovation Pty. Ltd., Northgate (AU)

(72) Inventors: Oliver James, Northgate (AU); Richard Bach, Northgate (AU); Anthony Sprague, Northgate (AU)

(73) Assignee: BluVein Innovation Pty. Ltd., Northgate, QL (AU)

(21) Appl. No.: 18/577,801

(22) PCT Filed: Jul. 9, 2021
(86) PCT No.: PCT/AU2021/050738

§ 371 Date: Jan. 9, 2024

(51) Int. Cl. B60L 53/16; B60L 50/60

(52) U.S. Cl. CPC B60L 53/16; B60L 50/60; B60L 2200/40

(57) ABSTRACT

An electric vehicle suitable for use in mining, the electric vehicle comprising at least one electric motor for providing motive power to the vehicle, at least one battery for supplying electricity to the at least one electric motor, a connector for connecting to an electrical conductor, whereby the electrical conductor provides electricity to the battery and/or vehicle when the connector is connected to the electrical conductor, wherein the battery has a power density of from 5000 to 20,000 W/kg and an energy density of from 5 to 100 Wh/kg. The battery may include tungsten oxide battery chemistry.

### TECHNICAL FIELD

The present invention relates to an electric vehicle and a system for operating the electric vehicle. In some embodiments, the vehicle is a heavy haulage vehicle, or a vehicle used in mining, such as in underground mining or open cut mining. In other embodiments the vehicle can be used in any mobile or static heavy duty application such as earth moving or road maintenance or situations where the vehicle may experience high power demands.

### BACKGROUND ART

Electric vehicles are becoming much more widespread. Indeed, in countries such as Norway, electric vehicles now account for more than half of the sales of new road going cars. Electric cars are typically powered by lithium ion batteries that have enough capacity to provide a driving range of anywhere from 180 km to 600 km, or more. Improvements in battery technology and fast charging technology means that recently developed electric cars can be charged from 20% battery capacity to 80% battery capacity in less than one hour. However, frequent fast charging of these electric cars can compromise battery life and battery capacity. Consequently, it is generally desirable to charge lithium ion battery powered electric cars at a relatively slow rate for most of the charging cycles of the electric car. Further, in a number of countries, charging infrastructure is deficient, thereby rendering electric vehicles significantly less practical for use, particularly if long distances need to be driven.

There have been some efforts to develop heavy haulage electric vehicles, such as trucks and mining vehicles. Most electric heavy haulage vehicles utilise lithium ion batteries to provide electrical power to the electric motor or motors that drive the vehicle. Due to the heavy weight that needs to be moved with these vehicles, the battery packs need to become very large, and hence very heavy. Even these very large battery packs still cannot store enough energy to make a viable mine haulage system.

Global mining trends show that globally, mines are getting deeper. Further, reducing ore grades are causing a shift to higher tonnage bulk underground mining operations. There is also increasing societal pressure to lower carbon intensity, lower carbon emissions and to increase use of renewable energy. There is also an increasing requirement for automation of mining fleets.

Most mining vehicles currently in use in surface and underground mines are powered by diesel engines. Although diesel engines are especially suitable for use in heavy haulage vehicles, by having high torque at low engine revs and reasonable fuel economy, diesel engines produce diesel particulates in the exhaust. Diesel particulates include nano diesel particulate material (“nano DPM”). These particles have been identified by the World Health Organisation and the United States Environmental Protection Agency as being carcinogenic to humans or likely to be carcinogenic to humans. Consequently, there is a push to reduce or remove diesel powered vehicles from mining operations.

Mining vehicles often have to haul heavy loads up steep and/or constant inclines. Current electric heavy haulage vehicles utilising batteries alone for electric power are generally not viable due to requirements in mining applications. These vehicles have massive batteries, which incurs a very high battery cost. The batteries need to be frequently swapped every 2 to 3 hours in order to enable high utilisation of the vehicle, because the charging time for the batteries would take the vehicle out of production for too long if on-board charging of the vehicle was used. This requires multiple batteries per vehicle. Extensive charging bay infrastructure and underground physical space is required to charge the batteries.

One possible solution involves providing electric vehicles that have on-board battery storage to provide electrical energy to the electric motors to drive the vehicle and also allow the vehicle to electrically connect to an electrical charging system during driving, in locations where the electrical charging system is located. For example, Evias AB, formerly known as Elways AB, has developed technology in which charging tracks or charging rails are located in a road surface or along a stretch of road. An electric vehicle is provided with an electrical connector. When the vehicle detects that it is in the vicinity of a charging track or charging rail, the connector automatically connects the vehicle to the charging track or charging rail. The vehicle then receives electrical power from the charging track or charging rail and that electrical power can be used to drive the vehicle, or to charge the battery in the vehicle, or, ideally, to both drive the vehicle and to charge the battery in the vehicle. As a result, the battery in the vehicle does not become depleted so quickly and, indeed, the battery in the vehicle can be charged whilst the vehicle is being driven. This has apparent advantages for vehicle range. Further, as the battery can be recharged whilst the vehicle is being driven, smaller batteries can also be used in the vehicle.

Evias AB have filed many patent applications for this technology, and a selection of these patent applications is set out below. The selection of patent applications set out below includes the patent application number, the title and the abstract of that application:

EP 2437959—A system adapted for one or more vehicles, which may be driven forward electrically—The present invention has its application to a system (“S”) for driving an electric and by one or more batteries powered vehicle (1) along a roadway, comprising “a” one or more vehicles (1), which may be driven by an individual electric motor (5) or motors and wherein the respective vehicles (1) exhibit a power-controlling control circuit (100, “R1”) for creating the necessary power and/or speed control and wherein required power i.a. can be provided primarily by a chargeable battery set (“B”, “II”) associated with the vehicle and “b” a plurality of road sections road portions (2a, 2b) divisible for the roadway, each being allotted one or more vehicle electrical electric stations (“si “, “III”) for charging the battery set (“B”, “II”) thereby and/or for supplying necessary power and energy for driving the vehicle (1). The underneath side of the mentioned vehicle (1) is provided with a contact means (4) displaceably positioned up and down and sideways, counted in the direction of transportation. Said roadway (2) and its road sections or portions (2b) exhibits an elongated track or groove (51, 52, 54), each road section (2al) is supporting two rails (4a, 4b) in the groove and disposed under the driving path of the road section or portion (2al). The rails (4a, 4b) being supplied with current and voltage. Said contact means (4) is coordinated with a control equipment (10) for creating simple adaptation of the contact means (4) for registering the contact means (4) for mechanical and electrical contact against said two rails (4a, 4b).

EP 2552728—A system adapted for one or more electrically propellable vehicles (arm shaped contact means)—Contact means (4) related to a vehicle are adapted to comprise an elongated arm (50), one end portion (50a) of which is rotatably attached to the underside (bottom) of the vehicle (1) and the other end portion (50b) of which is adapted to support said contact means (4). One or more sensors (15la, 151b) are disposed at the vehicle (1) and are intended to be able to sense the presence of and the orientation of a track or groove (51) and transfer sensed information to a power control circuit (100), which is adapted to comprise a control circuit (100b), which when sensing the existence of and a sensed orientation of at rack or groove (51), within a covered and restricted area, is to be adapted to actuate means (7) adapted to a sidewise movement and/or a lowering (or raising) movement at the contact means (4).

EP 2552729—A system adapted for one or more electrically propellable vehicles (contact means)—The present invention has its application to a vehicle-related arm-shaped contact means ((4)) related to a contact means arrangement as a current collector or system (“S”) for propelling an electrically, i.a. by batteries (“II”, B), propellable vehicle (1) along a roadway (2) comprising “a plurality of roadway portions (2a, 2al),wherein said road portions are allotted at least one track or slit (51, 52), having introduced therein current suppliable conductors (4a, 4b), and “b” one or more powerable vehicles (1), with each vehicle exhibiting a control circuit (100, “R1”) adapted for necessary distribution of power, wherein said vehicle (1) is on its underneath side provided with a displaceable contact means ((4)) as said current collectors. Said current collector (41,41′) is shaped as a main portion (141),made of an electrically insulating material, and having a lower surface (142) facing towards the contact surface (4a′) being shaped flat, and having a lower contact surface (144) consisting of an electrically conductive material (160). The electrically conductive material (160) is adapted to extend through the main portion (141) for forming one or more upper contact surfaces (146a) and/or connecting conductors (146b).

EP 2552731—A system adapted for one or more electrically propellable vehicles (rail structure)—This invention concerns a rail structure (70, 71, 72, 73) in a vehicle-related system (S) for driving an electric and by one or more batteries conveyable vehicle (1) along a stretch of a track in a roadway section (2al) and related to a roadway, comprising (a″) by one or more individual electric motors (5) drivable vehicles (1), and “b” a plurality of roadway sections (2a1, 2a) which may subdivide the stretch of roadway. Said tracks (51, 52) are in a cross section oriented in parallel in a rail structure (70), said rail structure (70) having electrical, of metal made, wall sections (71, 72) and a partition (73) separating the electrical wall sections. A first conductor surface ( ), which may be subjected to voltage, is allotted a lower portion for a first track (51). A second conductor surface (4b), which may be subjected to voltage, is allotted a lower portion for a second track (52).

EP 2552732—A system adapted for one or more electrically propellable vehicles (letting water pass by the electrical conductors)—This invention comprises an arrangement, adapted to letting water, rain water, melted ice and snow water or the like, to pass by electrical conductors (4a, 4b) and its contact surfaces (4a, 4b) and is related to a rail structure, where said arrangement, in the form of contact means ((4)) such as a current collector (41, 41) for driving an electric and by one or more batteries driven vehicle (1) along a stretch of roadway (2), adapted system (S) comprising: “a” one or more over an electric motor or individual electric motors (5) propellable vehicle (1) and “b” a plurality of road sections dividing the stretch of the roadway (2), each one being allotted one or more electric stations (“s1”, “III”) for thereby charging the batteries (B) of the vehicle (1) and/or supplying the required power and energy for driving the vehicle. At least three tracks (51a, 51, 52) are oriented parallel to each other in a common rail structure (30), where at least two of these tracks (51, 52) are adapted to support and enclose individual rails with contact surfaces (4a′, 4b′), which may be subjected to voltage, and that at least one track (5la) is disposed closer to the upper most portion (501) of the roadway (2) and adjacent to a track (51) for one of said rails (41) and its contact surface, which may be subjected to voltage.

EP 2552735—A system adapted for one or more electrically propellable vehicles (arrangement for metal detection)—This invention comprises an arrangement for metal detection and said arrangement is related to a system (“S”) adapted for driving a vehicle (1) electrically and by one or more batteries along a stretch of roadway, comprising “a” one or more over one or more electric motors propellable vehicles (1), with the respective vehicles (1) exhibiting a control circuit (100, “R1”) and “b” a plurality of roadway sections (2al, 2a) dividing the stretch of roadway, each roadway section being allotted one or more electric stations (“s1, “III”). Said vehicle (1) is on its bottom side provided with a up and down and sideways, counted in the direction of transportation, displaceably positioned contact means or current collector ((4)). Said roadway section (2al) exhibits, counted in the normal direction of transportation of the vehicle (1), elongated tracks (51) having rails (4a, 4b) positioned below the roadway and being capable of having current supply and being placed under voltage. Said contact means ((4)) are coordinated with control equipment (10) for creating simple adaptation of the contact means ((4)) for registering the contact means ((4)) against a mechanical and electrical contact with said rails (4a, 4b) over a detecting arrangement, adapted as a metal detector.

EP 2552739—A system adapted for one or more electrically propellable v (battery charging arrangement—This invention comprises a vehicle-related system (S) adapted for driving an electrically and by one or more batteries driven vehicle (1, 5) along a distance of a road-way, comprising; “a” one or more vehicles (1) driven by an individual electric motor or motors (5), wherein the respective vehicles (1) exhibit a control circuit (“R2”) for creating necessary power and/or speed control and wherein a required power can i.a. be supplied primarily by a battery set up (“II”, “B”) allotted to the vehicle and being chargeable, and “b” a plurality of road sections or portions (2al) subdividing the stretch of a roadway (2), each one allotted one or more electric stations (“III”, “s1”) in the form of an electrical source of power for thereof charging the battery set up (“II”, “B”) and/or supplying the necessary power and energy for driving the vehicle (1). A circuit (151), determining instantaneous power content of the battery set up, is adapted, in determining a predetermined level of power lying below a maximized power content, and in an occurring feed voltage for the electrical source of power (“III”, “s1”) to connect the electrical source of power over a switch (43a) allotted to the source of power for offering charging of the battery set and/or for offering power and energy feeding of said motor (5) over said circuit (“R1”) controlling the power.

EP 2552740—Overload restriction system for electrical vehicles—This invention comprises an arrangement for overload restriction, adapted to cooperate with a system (“S) for an electric and by one or more batteries or “a” battery set driven vehicle (1) to be driven along a stretch of roadway, comprising a one or more over an individual electric motor or motors drivable vehicles (1), with said respective vehicles (1) exhibiting a control circuit (100, “R1”) controlling the power for creating the necessary power and/or speed control, wherein a necessary power i.a. can be supplied primarily by a chargeable battery set (“B”) allotted to the vehicle, and “b” a plurality of a roadway sections (2al) subdividing the stretch of road, each one allotted to one or more electric stations (“s1”, “III”) for thereby charging the battery set (“II”; B) of the vehicle and/or supplying the necessary power and energy for driving the vehicle. The invention indicates that to said vehicles electrical source of power (“III”; 71; 42) is connected, at least to a chosen maximized power outlet, a withdrawn power limiting circuit (74a) and that this circuit (74a) is adapted, over a switch (44a) to supply the power to said conductor (4a, 4b) in its roadway section (2a2), during the time periods when the vehicle (1) passes said roadway section (2a2).

EP 2691257—Track related material structure—The present invention embraces a track-related material structure (60) intended to form at least one wall portion within an elongate track (51) or a slot along one or more road sections forming a stretch of road, where the track (51) at its upper end portion (512) arranged against the roadway of the stretch of road is assigned an earth connection (4c) and at its lower end portion (514) facing from the roadway is assigned one or more electrically current-feedable and energisable conductors (4a), wherein the material structure (60) is electrically insulating and oriented to the at least one wall portion of the track (51) and arranged to electrically and mechanically co-operate with said earth connection (4c).

EP 2828116-Add-on motor assembly—The present invention relates to an add-on motor assembly (10; 20) adapted to be connected to an existing vehicle (1) and configured to propel the vehicle along a road. The add-on motor assembly comprises at least one electric motor (12; 22) and further contact means (15) displaceable upwards, downwards and laterally and including a current collector, and a mechanism (16) for displacing the contact means. The contact means is adapted to co-act mechanically and electrically with an electric conductor (2) put under voltage and located in a road section on which the vehicle is travelling, in order to supply electric voltage to the at least one electric motor which thereby propels the vehicle.

EP 3815953—Electrically propellable vehicle comprising a current collector—Electrically propellable vehicle comprising at least one current collector being adapted to co-act with at least one rail element comprising at least one electric conductor. Each current collector comprises at least one contact element being adapted to connect mechanically and electrically with a corresponding contact portion of the at least one electric conductor. The vehicle further comprises a sliding device being displaceable in a lateral direction of the vehicle at an underside thereof. Each current collector is rotatably connected to the sliding device to rotate between a folded-down position where the at least one contact element of the current collector is substantially vertically disposed, and a folded-up position where the at least one contact element is non-vertically disposed. The at least one contact element of the current collector is vertically displaceable relative the vehicle or relative sliding device in the folded-down position. A corresponding method is also provided.

WO 2016/174030—System and method for electrical feeding of a vehicle—According to the invention, there is provided a system for electrical feeding of a vehicle, which system comprises at least one suspended rail element and at least one contact device. The rail element has at least one elongated groove or channel extending along a length of the rail element, wherein electric conductors to be put under voltage are arranged therein. The at least one contact device is directly or indirectly connectable to the vehicle, wherein the contact device is displaceable relative said vehicle and is configured to mechanically and electrically connect with the rail element from beneath in order to transmit electric current from said electric conductor to the vehicle. According to the invention, there is also provided a method for electrical feeding of a vehicle, and use of at least one suspended rail element for electrical feeding of a vehicle.

EP 2994337—Weatherproof track and contact for electrical feeding of road vehicles—A contact device (1) directly or indirectly connectable to a vehicle and adapted to co-act mechanically and electrically with a track (2) comprising an electric conductor (7) put under voltage and located in a road section (6) on which the vehicle is travelling, in order to supply electric voltage to at least one electric motor which propels the vehicle, wherein the contact device (1) is displaceable upwards, downwards and laterally and comprises at least one current collector and at least one cleansing device (4). The current collector (3) comprises a sliding contact (8) configured to be brought into mechanical and electrical contact with at least a vertical side wall portion of the track.

WO 2021/052947—System for electrical feeding of road vehicles—A system for electrical feeding of electrically propellable road vehicles is provided. The system comprises a rail element having at least one electric conductor extending in a lengthwise direction thereof and a current collector adapted to co-act with the rail element. The at least one electric conductor is arranged in at least one groove in the rail element and is adapted to be put under voltage. The rail element is adapted to be located in a road section on which the vehicle is travelling, wherein the current collector is connectable to the vehicle and is displaceable vertically and laterally and comprises at least one contact element. Each contact element is adapted to connect mechanically and electrically with a corresponding contact portion of the at least one electric conductor. The contact element and at least the contact portions of the electric conductors have a hardness being higher than that of quartz.

WO 2021/052948—System and method of for electrical feeding of road vehicles—A system comprising an electrically propellable vehicle and a rail element comprising at least one electric conductor arranged in at least one groove thereof and being adapted to be put under voltage for supplying electric power to the vehicle, and at least one electrically conducting ground conductor being connectable to ground potential. The vehicle is provided with a current collector adapted to co-act with the rail element, which is located in a road section on which the vehicle is adapted to travel, wherein the current collector is displaceable vertically and laterally and comprises at least one contact element and at least one ground contact element, being configured to be brought in electrical and mechanical contact with a corresponding electric conductor and ground conductor, respectively, wherein the at least one ground contact element is electrically connected to a chassis and/or body portion of the vehicle.

WO 2012134385—Flexible track structure—The present invention relates to a track structure, adapted to extend along a selected route (2a) and its assigned series-oriented road sections (2al, 2a2, 2a3), intended to be able to receive a vehicle-related current-collecting means (4), and comprising one or more elongated tracks (51, 52), which are assigned to each road section (2al, 2a2, 2a3), the track (51, 52) being defined by two side walls (53, 55) and a bottom wall (54) adapted to support a current-feedable and energizable electrical conductor (4a, 4b), and wherein said track structure (51, 52) comprises an outer cover (60) which surrounds the side walls and the bottom wall.

WO2021051233—Stationary charging arrangement and method for charging—A stationary charging arrangement for charging a battery or a set of batteries of an electrically propellable road vehicle while the vehicle is stationary. The arrangement comprises a rail element having at least one electric conductor extending in a lengthwise direction thereof, and a current collector adapted to co-act with the rail element, the electric conductor being arranged in at least one groove in the rail element and being adapted to be put under voltage, the current collector being connectable to the vehicle and being displaceable vertically and laterally to connect mechanically and electrically with the at least one electric conductor of the rail element for supplying electric power the vehicle. The rail element is adapted to be located in or on a parking lot on which the vehicle is parked. A system comprising such a charging arrangement and a corresponding method are also provided.

The vehicles and systems developed by Evias AB a very promising technology. However, some modifications or improvements to the vehicles and systems may be desirable for use in heavy haulage, particularly in mining applications.

It will be clearly understood that, if a prior art publication is referred to herein, this reference does not constitute an admission that the publication forms part of the common general knowledge in the art in Australia or in any other country.

### SUMMARY OF INVENTION

The present invention is directed to an electric vehicle which may at least partially overcome at least one of the abovementioned disadvantages or provide the consumer with a useful or commercial choice.

With the foregoing in view, the present invention in one form, resides broadly in an electric vehicle suitable for use in heavy duty applications such as mining, heavy haulage, earth moving or road maintenance, the electric vehicle comprising at least one electric motor for providing motive power to the vehicle, at least one battery for supplying electricity to the at least one electric motor, a connector for connecting to an electrical conductor, whereby the electrical conductor provides electricity to the battery and/or vehicle when the connector is connected to the electrical conductor, wherein the battery has a power density of from 5000 to 100,000 W/kg and an energy density of from 5 to 1000 Wh/kg.

In one embodiment, the battery allows for very fast charging. In one embodiment, the battery allows for very fast discharge.

In one embodiment, the battery can be discharged at greater than 2C, or greater than 5C, or greater than 10C, or greater than 20C, or greater than 50C, or greater than 100C, or greater than 200C, or greater than 300C, or greater than 400C, or even greater than 500C. In one embodiment, the battery can be discharged at up to 600C.

In one embodiment, the battery can be charged at greater than 2C, or greater than 5C, or greater than 10C, or greater than 20C, or greater than 50C, or greater than 100C, or greater than 200C, or greater than 300C, or greater than 400C, or even greater than 500C. In one embodiment, the battery can be charged at up to 600C.

In one embodiment, the battery has a power density of from 5000 to 1000,000 W/kg, or from 5000 to 90000 W/kg, or from 5000 to 80000 W/kg, or from 5000 to 70000 W/kg, or from 5000 to 60000 W/kg, or from 5000 to 50000 W/kg, or from 5000 to 40000 W/kg, or from 5000 to 30000 W/kg, or from 5000 to 20000 W/kg.

In one embodiment, the battery has an energy density of from 5 to 1000 Wh/kg, or from 5 to 900 Wh/kg, or from 5 to 800 Wh/kg, or from 5 to 700 Wh/kg, or from 5 to 600 Wh/kg, or from 5 to 500 Wh/kg, or from 5 to 400 Wh/kg, or from 5 to 300 Wh/kg, or from 5 to 200 Wh/kg, or from 5 to 100 Wh/kg.

In one embodiment, the battery includes tungsten oxide battery chemistry.

In one embodiment, the battery has tungsten oxide battery chemistry at the negative electrode. In one embodiment, the battery may have battery chemistry at the positive electrode that includes lithium chemistry. In one embodiment, the battery has WO₃, or WO_{2.72}, at the negative electrode active material. The positive electrode may include one or more of lithium cobalt oxide, lithium iron phosphate, or other lithium-based compound or compounds at the positive electrode. In other embodiments the battery may comprise any suitable chemistry as technology progresses to enable a high power density charge and discharge as described as described while maintaining safety and long life.

In one embodiment, the positive electrode contains no carbon. This is particularly useful in underground mining applications, as carbon free anodes/positive electrodes have a substantially reduced risk of thermal runaway.

The typical size of a battery used in a vehicle in accordance with the present invention may range from 60-100 kWh for smaller haul trucks to 100-600 kWh for larger vehicles. Charge and discharge rates may be in the order of 200 kW to 4 MW depending on vehicle and battery sizes. The ideal charge cycle may be from 1 minute to 60 minutes, or from 2 minutes to 60 minutes, or from 5 minutes to 60 minutes, or from 15-60 minutes.

In one embodiment, the electrical conductor to which the vehicle can electrically connect during driving may comprise a track or rail as described in one or more of the patent applications in the name of Evias AB or Elways AB, as mentioned above. In one embodiment, the track or rail is positioned above the vehicle during use. For example, if the vehicle is being used in an underground mining environment, the electrical conductor may be mounted to or suspended from a roof of the underground mine. In another embodiment, the electrical conductor may be mounted to or suspended from one or more poles or posts.

In one embodiment, the electrical conductor comprises a slotted rail, the slotted rail having at least one slot with sidewalls and an opening extending along the slot, the slot having a conductive region located away from the opening of the slot. In this manner, the electrical connector can comprise an electrically conductive portion that extends into the opening in the slot and comes into electrical contact with the conductive region of the slotted rail. In this embodiment, the conductive region is effectively spaced from the opening to the slot, thereby making accidental contact with the conductive region unlikely which, in turn, increases the electrical safety associated with the product.

In one embodiment, the connector can move away from the vehicle to connect to the electrical conductor and move towards the vehicle to disconnect from the electrical conductor.

In one embodiment, the connector on the vehicle comprises a connector that extends upwardly to connect to the electrical conductor when the vehicle senses that it is in close proximity to the electrical conductor. In one embodiment, the connector comprises a pantograph. In one embodiment, the connector can move upwardly to a connected position. In one embodiment, the connector includes a connecting region that connects with the electrical conductor. In one embodiment, the connecting region can move upwardly and laterally to connect to the electrical conductor and can move downwardly when the vehicle is no longer in close proximity to the electrical connector.

In one embodiment, the connector on the vehicle comprises a connector that extends laterally or sideways to connect to the electrical conductor when the vehicle senses that it is in close proximity to the electrical conductor. In one embodiment, the connector can move sidewardly to a connected position. In one embodiment, the connector includes a connecting region that connects with the electrical conductor. In one embodiment, the connecting region can move upwardly and laterally to connect to the electrical conductor and can move back towards the vehicle when the vehicle is no longer in close proximity to the electrical connector. It can be appreciated that there may be a range of embodiments that the connector could move in any direction relative to the vehicle to connect/disconnect to and from the conductor.

In one embodiment, the connector comprises a base, an arm adapted to move upwardly and downwardly, the arm adapted to move laterally across the base, the arm carrying an electrically connecting portion.

By providing an electric vehicle with the battery as specified in the present invention, the battery can be rapidly charged when the electric vehicle is electrically connected to the electrical conductor. Further, the electrical vehicle, in some embodiments, can be driven by electricity obtained from the electrical conductor when the vehicle is electrically connected to the electrical conductor. When the vehicle moves away from the electrical conductor, the electrical vehicle can be driven by electricity obtained from the on-board battery.

By providing a battery that can be charged whilst it is being driven, the vehicle never needs to stop for charging and smaller, lower cost battery packs can be used. Desirably, no battery swaps are required.

In a second aspect, the present invention provides a system for use heavy duty applications such as mining, heavy haulage, earth moving or road maintenance, the system comprising an electric vehicle, the electric vehicle comprising at least one electric motor for providing motive power to the vehicle, at least one battery for supplying electricity to the at least one electric motor, a connector for connecting to an electrical conductor, whereby the electrical conductor provides electricity to the battery and/or at least one electric motor when the connector is connected to the electrical conductor, wherein the battery has a power density of from 5000 to 100,000 W/kg and an energy density of from 5 to 1000 Wh/kg, the system further comprising at least one electrical conductor mounted or positioned along a route traversed by the electric vehicle, wherein the connector of the vehicle connects to the electrical conductor when the vehicle is in close proximity to the electrical conductor.

In one embodiment, the system of the second aspect of the present invention is used in mining. In one embodiment, the electrical conductor is mounted along at least part of a route traversed by the electric vehicle. In one embodiment, at least one electrical conductor is mounted along one or more inclined sections of the route. This allows the electric vehicle to obtain electrical power from the electrical conductor as the electric vehicle drives along the inclined section of the route. This minimises drainage of the battery and allows the battery to be charged whilst the vehicle is driving along the inclined section of the route, particularly when the electric vehicle is driving up the inclined section of the route.

In one embodiment, the system of the second aspect of the present invention is used in an underground mine and the at least one electrical conductor is mounted to or suspended from a roof of the mind. In one embodiment, the at least one electrical conductor is located along an inclined section of the mine.

In one embodiment, the electrical conductor is mounted above a road surface. In one embodiment, the electrical conductor is mounted to a roof. In another embodiment, the electrical conductor is mounted to or suspended from one or more posts or poles, or mounted to or suspended from a sidewall.

In one embodiment, the electrical conductor comprises a rail or a track. The electrical conductor may comprise a slotted rail providing protected electrical contacts. The rail or track may be obtained from Evias AB, or it may be as described with reference to one or more of EP 2437959, EP 2552729, EP 2552731, EP 2691257, or WO 2016/174030, the entire contents of which are described herein. The rail or track is suitably positioned above the vehicle in use (it is noted that the above patents focus on having the rail track mounted in the roadway surface and hence underneath the vehicle).

The vehicle may be as described with reference to EP 3815953, the entire contents of which are here incorporated by reference. In one embodiment of the present invention, the electrical connector moves upwardly into contact with an overhead electrical conductor.

In one embodiment, the connector is of complementary shape to enable the connector to be electrically connected to the electrical conductor. The connector may be as described with reference to connectors available from Evias AB, or as described in one or more of EP 2552728 or EP 2552735, the entire contents of which are incorporated herein by cross-reference.

In one embodiment, the connector is mounted to the vehicle and the connector moves upwardly to move into electrical and mechanical contact with the electrical conductor. The connector may include a pantograph. Alternatively, the connector may include an extendable arm, or an arm that can be raised and lowered.

The battery of the vehicle used in the second aspect of the present invention may be as described for the battery of the vehicle in the first aspect of the present invention.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a diagram of an electric vehicle and an external electrical conductor in accordance with one embodiment of the present invention;

FIG. 2 shows a perspective view of an electrical conductor in accordance with one embodiment of the present invention;

FIG. 3 shows the electrical conductor of FIG. 2 connected to the roof of a mine;

FIG. 4 shows a diagram of an electrical connector in accordance with an embodiment of the present invention that can be mounted to a vehicle;

FIG. 5 shows a view of the base of the connector shown in FIG. 4;

FIG. 6 shows an electrically powered truck having the electrical connector shown in FIGS. 4 and 5 mounted thereto;

FIG. 7 shows a view of the truck of FIG. 6 with the electrical connector being connected to an external electrical conductor;

FIG. 8 shows a view of another vehicle having the electrical connector mounted thereto; and

FIG. 9 shows a schematic view of use of an electrical vehicle in accordance with the present invention in an underground mine.

### DESCRIPTION OF EMBODIMENTS

It will be appreciated that the drawings have been provided for the purpose of describing preferred embodiments of the present invention. Therefore, it will be understood that the present invention should not be considered to be limited solely to the features as shown and described in the drawings.

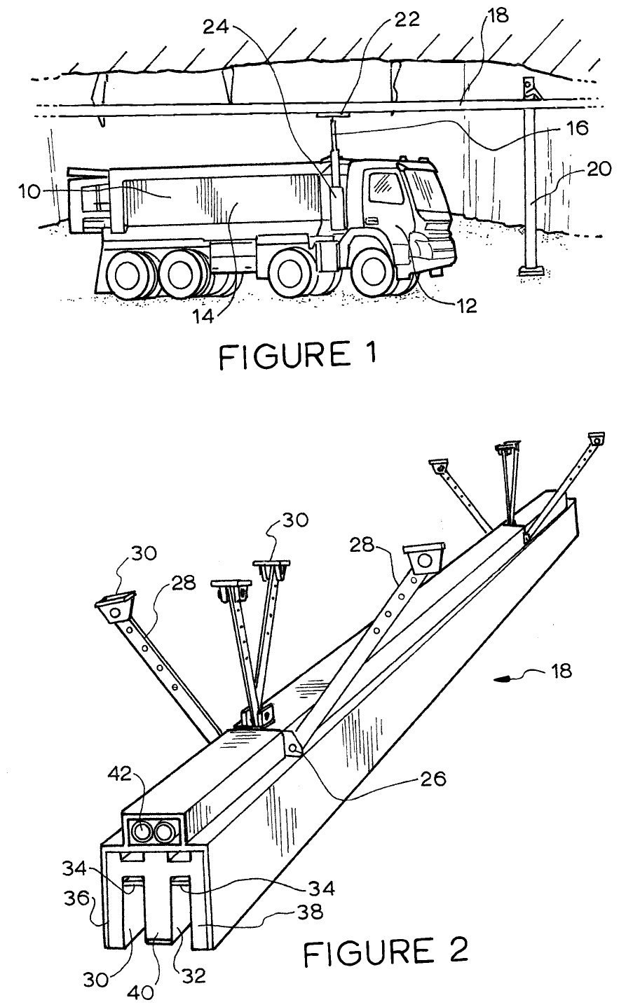

FIG. 1 shows a diagrammatic view of an electric vehicle 10 in accordance with one embodiment of the present invention. The electric vehicle 10 is in the form of a heavy haulage truck having a cabin 12 and a tray 14 for hauling load. The vehicle 10 also includes a connector 16 that can electrically connect to an electrically conductive rail or track 18. The rail track 18 is suspended from or mounted to a plurality of poles or posts, one of which is shown at 20.

The electrical connector 16 includes an electrically connecting region 22 that can electrically connect to a conductive region of the rail or track 18. The electrically connecting region 22 is mounted at one end of an arm 24. The arm 24 can be moved toward and away from the vehicle, such as raised or lowered or it can move upwardly or downwardly or it can move or extend sideways away from the vehicle and move sideways towards the vehicle. The arm 24 maybe a telescopic arm or it may be pivotally mounted. In some embodiments, the arm 24 can move laterally relative to the longitudinal axis of the vehicle 10. One embodiment for achieving this will be described in more detail hereunder.

FIG. 2 shows a more detailed view of the track or rail 18. In the embodiment shown in FIG. 2, the track or rail 18 is intended to be suspended from or mounted to a roof of a mine. The track or rail 18 has brackets 26 attached thereto. The brackets 26 have a plurality of arms 28 connected thereto. The arms 28 have connecting brackets 30 connected to the other end thereof. The connecting brackets 30 enable the arms 28, and hence the track rail 18, to be mounted to the roof of a mine, for example, by use of appropriate bolts.

The track or rail 18 may be as described in EP 2552731 (corresponding to WO 2011/123049). The track or rail 18 includes two slots 30, 32. The slots 30, 32 each have an opening, opposed sidewalls and a closed top. A first conductor surface 34 extends along the closed top of the slots 30, 32. The first conductor surface 34 may extend along a part of the sidewalls of the slots 30, 32, but will finish short of the opening to the slots. The sidewalls 36, 38 of the track or rail 18 and the intermediate wall 40 between the slots 30 and 32 are made from an electrically insulating material. Consequently, the conductive parts of the track or rail 18 that carry electrical current are present in the slots and are largely guarded against accidental or casual contact by the electrically insulating material that forms the sidewalls 36, 38 and intermediate wall 40 of the track 18.

The track or rail 18 is also provided with appropriate cabling or wiring, schematically shown at 42, to provide electrical current to the track or rail 18. The wiring or cabling 42 is connected to a source of electrical power and it also provides electrical power to the first conductor surface 34 in both slots. The electrical power is suitably DC power, but it may also be AC if required.

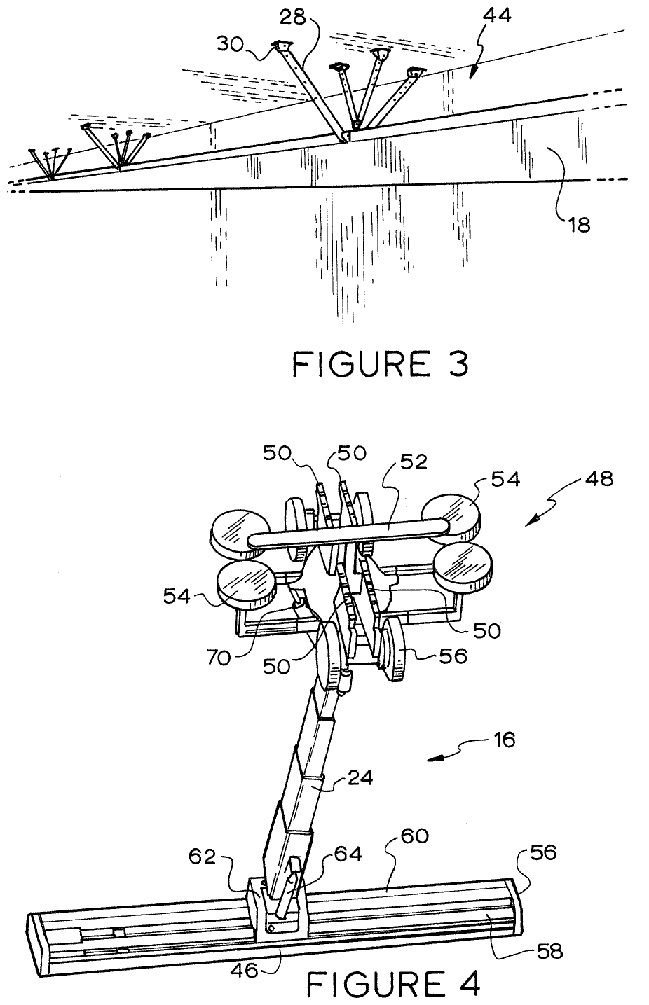

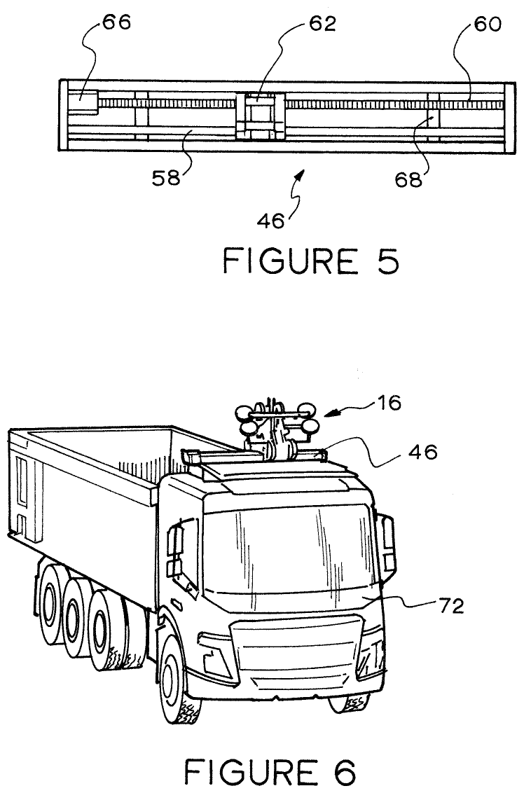

FIG. 3 shows the track or rail 18 connected via the arms 28 and the brackets 30 to the roof 44 of a mine.

FIG. 4 shows a view of a connector suitable for use with the electric vehicle of the present invention. The connector forms an electrical connection between the vehicle and the electrical conductor and allows electricity from the electrical conductor to be passed to the vehicle. The connector 16 includes an arm 24 that is pivotally mounted to a base 46. The other end of the arm 24 has an electrical connection arrangement 48. The electrical connection arrangement 48 includes sliding electrical contact members 50 that are adapted to be inserted into the slots 30, 32 of the track or rail 18. The sliding electrical contact members 50 are mounted on movable frames so that they can move upwardly and downwardly relative to flat rod 52 that extends transversely to the track or rail 18. The movable frames carry horizontal rollers 54 and vertical rollers 56. In use, the horizontal rollers 54 roll along the outer vertical walls of the track or rail 18 and the horizontal rollers 56 roll along the bottom surface of the sidewalls 36, 38 of the track or rail 18.

The base 46 includes a frame 56 that can be mounted to the vehicle 10. The frame 56 includes a support rod 58 and a drive rod 60. A base platform 62 has the arm 24 connected thereto in a pivotal manner. A hydraulic ram or a pneumatic ram 64 can be extended and retracted to respectively raise and lower the arm 24. A drive rod motor 66 can turn the drive rod which, in turn, can move the support base 62 along the drive rod and therefore along the support rod 58. This can be used to adjust the lateral position of the arm 24. The base 46 also has a position sensor 68 that can determine the position of the base platform 62 (and hence the position of the arm 24) along the drive rod 60.

In use, as the vehicle 10 approaches a region at which a track or rail 18 has been mounted to the roof of the mine, sensors determine that the vehicle is in close proximity to the track or rail. A control system (not shown) then extends the arm 24 and the drive rod 60 is rotated to move the lateral position of the arm 24 so that the sliding electrical contact members 50 are brought into alignment with the slots 30, 32 of the track or rail 18. Rams 70 are then operated to move the frames holding the sliding electrical contact members 50 into register with the slots 30, 34 such that the sliding electrical contact members 50 contact the first conductor surfaces 34 in the tracks or rails 18. This establishes an electrical connection between the track or rail 18 and the vehicle 10. As a result, electrical power is supplied from the track or rail 18 to the electrical vehicle 10, which allows the on-board batteries in the electrical vehicle 10 to be charged and the motors that move the electric vehicle 10 to be energised by electricity from the track or rail 18. The flat rod 52 slides along the lower surface of the track or rail 18 and appropriate sensors and control system (not shown) ensure that the flat rod 52 stays in contact with the bottom of the track or rail 18. This ensures that the sliding electrical contact members 50 remain in the electrical contact with the first conductor surfaces 34 of the track or rail 18.

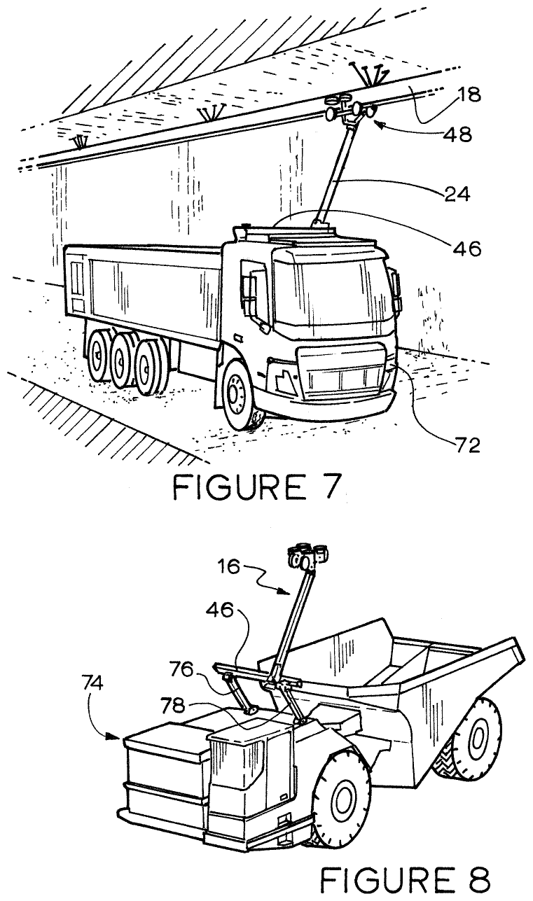

FIG. 6 shows the connector 16 being mounted to an electric truck 72. As can be seen from FIG. 6, the base 46 is mounted to the cabin region of the truck. FIG. 7 shows the truck 72 having the base 46 mounted thereto, with the arm 24 being extended and the electrical connection arrangement 48 being mechanically and electrically engaged with the track or rail 18.

FIG. 8 shows a piece of earthmoving machinery 74 having the base 46 of the connector 16 being mounted to arms 76, 78. The arms 76, 78 can be pivoted upwardly and downwardly to provide further adjustability to the height of the connector 16.

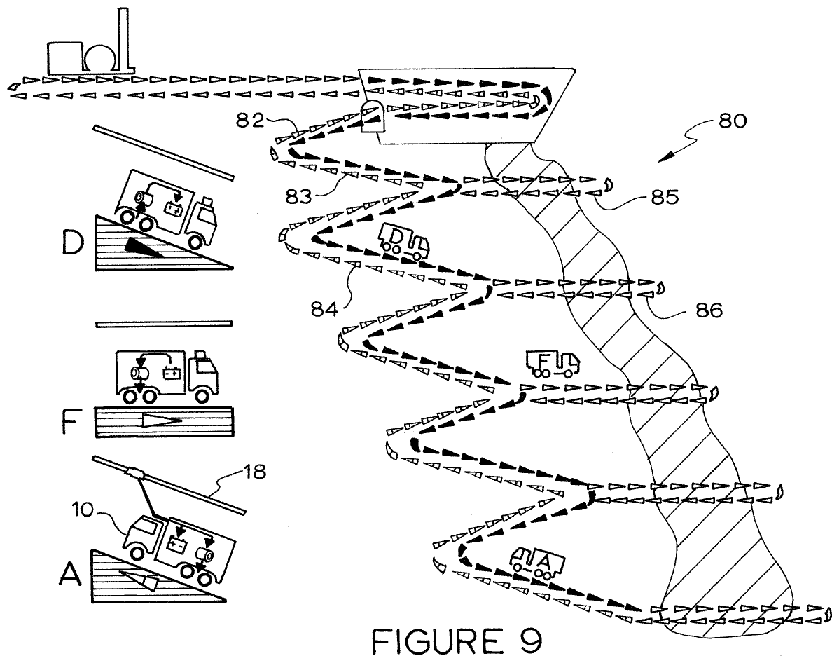

FIG. 9 shows a schematic diagram of a mine 80 having a series of incline roadways, some of which are numbered at 82, 83, 84, etc, and a series of horizontal tunnels, some of which are numbered at 85, 86. Tracks or rails 18 are mounted in the mine at the inclines. No tracks or rails are mounted in the horizontal tunnels 85, 86, etc. When the electric vehicle 10 is driving up an incline, the connector 16 connects to the track or rail 18 so that the track or rail 18 supplies electricity to the vehicle 10 to drive the vehicle and to charge the on-board batteries. When the vehicle 10 is travelling back down the incline, the vehicle 10 can use its on-board regenerative braking system to charge the on-board batteries. The vehicle does not need to be electrically connected to the track or rail 18 when going back down the inclines. Of course, it will be understood that the vehicle could be connected to the track or rail during descent of the inclines. When the vehicle 10 is being driven in the flat tunnels 85, 86, the connector 10 is disengaged from any tracks or rails, as tracks or rails are not mounted in those sections of the mine. The vehicle is then driven by its on-board batteries. As the vehicle is driving in a flat section of the mine, power consumption from the batteries is not excessive.

The on-board batteries included in the vehicle 10 have an anode that may include tungsten oxide battery chemistry. The batteries may have a lithium cobalt oxide-based cathode. These batteries may operate at a voltage of from 1.5 to 2.65 V and may have a specific energy of between 20 and 25 Wh/kg. The batteries may have a maximum power density of up to 20,000 W/kg, or around 16,500 W/kg. These batteries have been tested to charge and discharge at 5C or higher. Cycle life is expected to be greater than 5000 charge/discharge cycles. The anode is suitably carbon free to minimise the risk of thermal runaway and to minimise the risk of battery fire. These batteries may be purchased from, for example, Toshiba Materials.

The vehicle and system of preferred embodiments of the present invention has the following advantages over conventional electrical vehicles and diesel powered vehicles:
eliminate battery swapping and haulage interruption
eliminate requirements for multiple batteries per vehicle
eliminate or minimise charge infrastructure and physical space required
allow the use of smaller, lighter and cheaper batteries
enable faster up-ramp haul speeds whilst simultaneously charging the on-board battery
allows for fully electric vehicle haulage in the minds, which eliminates diesel particulate material and has the capability of reducing operating costs of the mine.

The present invention uses batteries that are capable of delivering high charging and discharging rates with less importance placed on maximising energy storage capacity. This is enabled by the use of dynamic charging technology that allows the batteries to be charged whilst the vehicle is being driven. This enables vehicles in accordance with the present invention to be used for heavy haulage, such as in mines.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An electric vehicle suitable for use in heavy duty applications such as mining, heavy haulage, earth moving or road maintenance, the electric vehicle comprising at least one electric motor for providing motive power to the vehicle, at least one battery for supplying electricity to the at least one electric motor, a connector for connecting to an electrical conductor, whereby the electrical conductor provides electricity to the battery and/or vehicle when the connector is connected to the electrical conductor, wherein the battery has a power density of from 5000 to 100,000 W/kg and an energy density of from 5 to 1000 Wh/kg.

2. The electric vehicle as claimed in claim 1, wherein the battery can be discharged at greater than 2C, or greater than 5C, or greater than 10C, or greater than 20C, or greater than 50C, or greater than 1000, or greater than 2000, or greater than 3000, or greater than 4000, or even greater than 5000, or wherein the battery can be discharged at up to 6000.

3. The electric vehicle as claimed in claim 1, wherein the battery can be charged at greater than 2C, or greater than 5C, or greater than 10C, or greater than 20C, or greater than 50C, or greater than 1000, or greater than 2000, or greater than 3000, or greater than 4000, or even greater than 5000, or wherein the battery can be charged at up to 6000.

4. The electric vehicle as claimed in claim 1, wherein the battery has a power density of from 5000 to 1000,000 W/kg, or from 5000 to 90000 W/kg, or from 5000 to 80000 W/kg, or from 5000 to 70000 W/kg, or from 5000 to 60000 W/kg, or from 5000 to 50000 W/kg, or from 5000 to 40000 W/kg, or from 5000 to 30000 W/kg, or from 5000 to 20000 W/kg.

5. The electric vehicle as claimed in claim 1, wherein the battery has an energy density of from 5 to 1000 Wh/kg, or from 5 to 900 Wh/kg, or from 5 to 800 Wh/kg, or from 5 to 700 Wh/kg, or from 5 to 600 Wh/kg, or from 5 to 500 Wh/kg, or from 5 to 400 Wh/kg, or from 5 to 300 Wh/kg, or from 5 to 200 Wh/kg, or from 5 to 100 Wh/kg.

6. The electric vehicle as claimed in claim 1, wherein the battery includes tungsten oxide battery chemistry.

7. The electric vehicle as claimed in claim 1, wherein a positive electrode of the battery contains no carbon.

8. The electric vehicle as claimed in claim 1, wherein the battery has a capacity of from 60-600 kWh, or from 60-100 kWh for smaller haul trucks or from 100-600 kWh for larger vehicles, or charge and discharge rates are in the order of 200 kW to 4 MW and the charge cycle is from 1 minute to 60 minutes, or from 2 minutes to 60 minutes, or from 5 minutes to 60 minutes, or from 15-60 minutes.

9. The electric vehicle as claimed in claim 1, wherein the electrical conductor to which the vehicle can electrically connect during driving may comprise a track or rail.

10. The electric vehicle as claimed in claim 1, wherein the electrical conductor comprises a slotted rail, the slotted rail having at least one slot with sidewalls and an opening extending along the slot, the slot having a conductive region located away from the opening of the slot and the electrical connector comprises an electrically conductive portion that extends into the opening in the slot and comes into electrical contact with the conductive region of the slotted rail.

11. The electric vehicle as claimed in claim 1, wherein the connector can move away from the vehicle to connect to the electrical conductor and move towards the vehicle to disconnect from the electrical conductor.

12. The electric vehicle as claimed in claim 11, wherein the connector on the vehicle comprises a connector that extends upwardly to connect to the electrical conductor when the vehicle senses that it is in close proximity to the electrical conductor, or the connector includes a connecting region that connects with the electrical conductor and the connecting region can move upwardly and laterally to connect to the electrical conductor and can move downwardly when the vehicle is no longer in close proximity to the electrical connector.

13. The electric vehicle as claimed in claim 11, wherein the connector on the vehicle comprises a connector that extends laterally or sideways to connect to the electrical conductor when the vehicle senses that it is in close proximity to the electrical conductor, or the connector includes a connecting region that connects with the electrical conductor and the connecting region can move upwardly and laterally to connect to the electrical conductor and can move back towards the vehicle when the vehicle is no longer in close proximity to the electrical connector.

14. A system for use in heavy duty applications such as mining, heavy haulage, earth moving or road maintenance, the system comprising an electric vehicle, the electric vehicle comprising at least one electric motor for providing motive power to the vehicle, at least one battery for supplying electricity to the at least one electric motor, a connector for connecting to an electrical conductor, whereby the electrical conductor provides electricity to the battery and/or at least one electric motor when the connector is connected to the electrical conductor, wherein the battery has a power density of from 5000 to 100,000 W/kg and an energy density of from 5 to 1000 Wh/kg, the system further comprising at least one electrical conductor mounted or positioned along a route traversed by the electric vehicle, wherein the connector of the vehicle connects to the electrical conductor when the vehicle is in close proximity to the electrical conductor.

15. The system as claimed in claim 14, wherein the electrical conductor is mounted along at least part of a route traversed by the electric vehicle and at least one electrical conductor is mounted along one or more inclined sections of the route.

16. The system as claimed in claim 14, wherein the system is used in an underground mine and the at least one electrical conductor is mounted to or suspended from a roof of the mine, or the electrical conductor is mounted above a road surface, or the electrical conductor is mounted to or suspended from one or more posts or poles, or mounted to or suspended from a sidewall, or the at least one electrical conductor is located along an inclined section of the mine.

17. The system as claimed in claim 14, wherein the electric vehicle comprises an electric vehicle as claimed in of claim 1.
